(19) United States
(12) Patent Application Publication
(10) Pub. No.: US 2022/0008790 A1
(43) Pub. Date: Jan. 13, 2022

(54) RESISTANCE ADJUSTMENT SYSTEM FOR STATIONARY EXERCISE EQUIPMENT

(71) Applicant: YU-YU CHEN, TAIPEI CITY (TW)

(72) Inventor: YU-YU CHEN, TAIPEI CITY (TW)

(21) Appl. No.: 17/368,111

(22) Filed: Jul. 6, 2021

(30) Foreign Application Priority Data
Jul. 8, 2020 (TW) 109123011
Mar. 23, 2021 (TW) 110203111

(51) Int. Cl. A63B 24/00; H02K 49/04; A63B 21/22; A63B 71/06; A63B 21/005; A63B 21/00

(52) U.S. Cl. CPC A63B 24/0087; H02K 49/046; A63B 21/225; A63B 71/0619; A63B 2071/0675; A63B 21/00069; A63B 21/0052; A63B 2220/24; A63B 21/0058

(57) ABSTRACT

A resistance adjustment system for adjusting a resisting force to a flywheel of a stationary exercise equipment is provided, including a resistance control circuit, a manual adjustment member, a power unit, a transmission assembly, and a resistance device. The power unit is in electrical connection with the resistance control circuit, wherein, in response to receipt of a resistance adjustment signal from the manual adjustment member, the resistance control circuit generates a driving signal to drive the power unit. The power unit then moves the resistance device via a transmission assembly to cause a change of the resisting force to the flywheel.

### BACKGROUND OF THE INVENTION

### 1. Field of the Invention

The present invention relates to stationary exercise equipment, and more particularly to an intelligent resistance adjustment system for stationary exercise equipment.

### 2. The Related Arts

Resistance systems for traditional flywheel-based stationary bicycles are generally classified in two types, which are permanent magnet resistance system and electromagnetic resistance systems. For control and variation of the resistance, the permanent magnet resistance system (also referred to as “hard magnet”) totally relies on manual operations to make desired variation. Consequently, there will always be time delay in responding and no instantaneous response may be achieved, and as such, it does not provide synchronization for use with landforms and terrain features (such as moving uphill or downhill or emergence braking) of a virtual-reality environment.

The electromagnetic resistance system (also referred to as “soft magnet”) is capable of making instantaneous response for varying resistance. However, it does not make response to situations of emergency braking, and is also not available for change of difficulty level in respect of resistance offset, if it is not combined with and controlled by an intelligent resistance adjustment device, and thus, it is not suit for to different sorts of virtual-reality software.

In brief, the known resistance adjustment systems for flywheel-based stationary exercise equipment suffers the following drawbacks:

(1) The known permanent magnet resistance system relies on manual operation to control and vary resistance, and there is a time delay in responding to resistance variation, and thus, it does not provide an effect of computer-controlled instantaneous response.

(2) The known permanent magnet resistance system relies on manual operation to control and vary resistance, and is thus not applicable to situations of change in virtual reality that requires immediate responses.

(3) The known permanent magnet resistance system suffers time delay in responding to resistance variation, and thus, it is not suit for scenario of slope variation in virtual reality.

(4) The known electromagnetic resistance system, although capable of instantaneous response to resistance variation, lacks connection with intelligent resistance adjustment and is thus incapable of emergent response to an instantaneous situation of a man-vehicle interface.

(5) The known electromagnetic resistance system, although capable of instantaneous response to resistance variation, lacks connection with intelligent resistance adjustment and is thus incapable of allowing for enjoyment of interaction with a man-vehicle interface.

(6) The known electromagnetic resistance system does not include an intelligent resistance adjustment device, and this leads to severe concern of fairness for group training or competition.

(7) The known electromagnetic or permanent-magnet resistance system does not include an intelligent resistance adjustment device, and this makes it impossible for change of difficulty level in virtual reality.

(8) The known electromagnetic or permanent-magnet resistance system lacks integration with a man-vehicle interface of an intelligent resistance adjustment device, and this makes it impossible for a user to take functional threshold power (FTP) training.

(9) The known electromagnetic or permanent-magnet resistance system lacks connection with a man-vehicle interface of an intelligent resistance adjustment device, and this makes it impossible to enable a user to take cardiovascular training.

(10) The known electromagnetic or permanent-magnet resistance system lacks connection with a man-vehicle resistance control and drive device so as not to enable a user to achieve such a level of man-machine-computer integration during the exercise training.

### SUMMARY OF THE INVENTION

Thus, the primary objective of the present invention is to provide a resistance adjustment system for stationary exercise equipment, which helps improve the drawbacks of a known stationary bicycle resistance system and provides an intelligent resistance system for stationary exercise equipment that is fit for virtual reality technology and group exercise training.

The technical solution adopted in the present invention comprises a casing mounted to a frame of the stationary exercise equipment; a resistance control circuit arranged in the casing; a pushbutton-fashion manual adjustment member including an increment button and a decrement button electrically connected to the resistance control circuit, operable by a user to generate a resistance adjustment signal to the resistance control circuit; a power unit, which is in electrical connection with the resistance control circuit, wherein, in response to receipt of the resistance adjustment signal from the manual adjustment member, the resistance control circuit generates a driving signal to drive the power unit; a transmission assembly, which has an end connected to the power unit; and a resistance device connected to an opposite end of the transmission assembly, wherein the power unit drives, via the transmission assembly, the resistance device to move so as to cause a change of the resisting force applied to the flywheel.

In another embodiment, the present invention comprises a resistance control circuit with a signal input/output interface for receiving a resistance value signal transmitted from an electronic device; a power source for supplying electricity to the signal input/output interface and the resistance control circuit; a transmission assembly; a manual adjustment member coupled to the transmission assembly; and an electrical adjustment member including an electromagnetic drive unit electrically connected to the electromagnetic resistance device, wherein the electromagnetic drive unit includes an electromagnet signal transceiver and an electromagnetic drive circuit in electrical connection with the electromagnet signal transceiver, wherein the resistance value signal transmitted from the electronic device is transmitted through the signal input/output interface to the electromagnet signal transceiver to allow the electromagnetic drive circuit to drive the electromagnetic resistance device to cause a change of the resisting force applied to the flywheel.

In efficacy, the structural arrangement of the present invention is fit for the virtual reality technology and the need for group exercise training, exercise power training, and cardiovascular training in virtual reality, for being used in a virtual-reality landform (such as slope variation for uphill and downhill and various levels of riding difficulty in respect of resistance and level shifting of resistance), or terrain features (such as emergency braking), or change among different difficulty levels in virtual reality, and so on, for realization of synchronization with various situations in virtual reality, so that during exercise training, the user may achieve a scenario of unification among man, machine, and controller. Further, the structural arrangement of present invention allows for enjoyment of the interesting of instantaneous man-vehicle interaction for emergency and an interaction process of the man-vehicle interface.

The dual-mode resistance adjustment device as provided in the present invention allows a user to make adjustment, as desired, for the resisting force applied to a flywheel according to an electrical operation mode or a manual operation mode to suit the needs and interesting of group exercise training, exercise power training, and cardiovascular training.

A specific technique solution adopted in the present invention will be further described below with reference to examples of embodiments of the present invention and the attached drawings.

### BRIEF DESCRIPTION OF THE DRAWINGS

FIG. 1A is a schematic view illustrating a first embodiment of the present invention mounted to a frame of a stationary bicycle;

FIG. 1B is a perspective view illustrating a resistance device of the first embodiment of the present invention arranged at a location adjacent to a flywheel;

FIG. 1C is a side elevational view illustrating a resistance device of the first embodiment of the present invention arranged at a location adjacent to a flywheel;

FIG. 2 is a cross-sectional view taken along line A-A of FIG. 1C;

FIG. 3 is a circuit block diagram of the first embodiment of the present invention shown in FIGS. 1 and 2;

FIG. 4 is a side elevational view illustrating a resistance device of a second embodiment of the present invention arranged at a location adjacent to a flywheel;

FIG. 5 is a circuit block diagram of the second embodiment of the present invention shown in FIG. 4;

FIG. 6 is a side elevational view illustrating a resistance device of a third embodiment of the present invention arranged at a location adjacent to a flywheel;

FIG. 7 is a circuit block diagram of the third embodiment of the present invention shown in FIG. 6;

FIG. 8A is a perspective view illustrating a positional relationship of type I of a fourth embodiment of the present invention corresponding to a flywheel;

FIG. 8B is a side elevational view illustrating the positional relationship of type I of the fourth embodiment of the present invention corresponding to a flywheel;

FIG. 9A is a perspective view illustrating a positional relationship of type II of the fourth embodiment of the present invention corresponding to a flywheel;

FIG. 9B is a side elevational view illustrating the positional relationship of type II of the fourth embodiment of the present invention corresponding to a flywheel;

FIG. 10A is a perspective view illustrating a positional relationship of type III of the fourth embodiment of the present invention corresponding to a flywheel;

FIG. 10B is a side elevational view illustrating the positional relationship of type III of the fourth embodiment of the present invention corresponding to a flywheel;

FIG. 11A is a perspective view illustrating a positional relationship of type IV of the fourth embodiment of the present invention corresponding to a flywheel;

FIG. 11B is a side elevational view illustrating the positional relationship of type IV of the fourth embodiment of the present invention corresponding to a flywheel;

FIG. 12 is a circuit block diagram of the fourth embodiment of the present invention shown in FIGS. 8A-11B;

FIG. 13 is a side elevational view illustrating a positional relationship of a resistance device of a fifth embodiment of the present invention corresponding to a flywheel;

FIG. 14 is a circuit block diagram of the fifth embodiment of the present invention shown in FIG. 13;

FIG. 15 is a schematic view illustrating a stationary exercise equipment resistance adjustment device according to a sixth embodiment of the present invention mounted to a frame of a stationary bicycle;

FIG. 16 is a perspective view illustrating a positional relationship of the resistance adjustment device of FIG. 17 corresponding to a stationary bicycle flywheel;

FIG. 17 is a perspective view of the resistance adjustment device shown in FIG. 17;

FIG. 18 is an exploded view showing a condition that components of FIG. 17 are separated from each other;

FIG. 19A is a cross-sectional view taken along line B-B of FIG. 17;

FIG. 19B is a cross-sectional view taken along line C-C of FIG. 17; and

FIG. 20 is a circuit block diagram of the sixth embodiment of the present invention shown in FIGS. 15-19B.

### DETAILED DESCRIPTION OF THE PREFERRED EMBODIMENTS

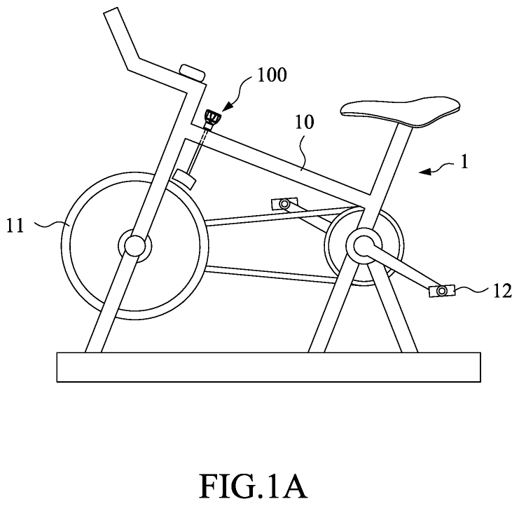

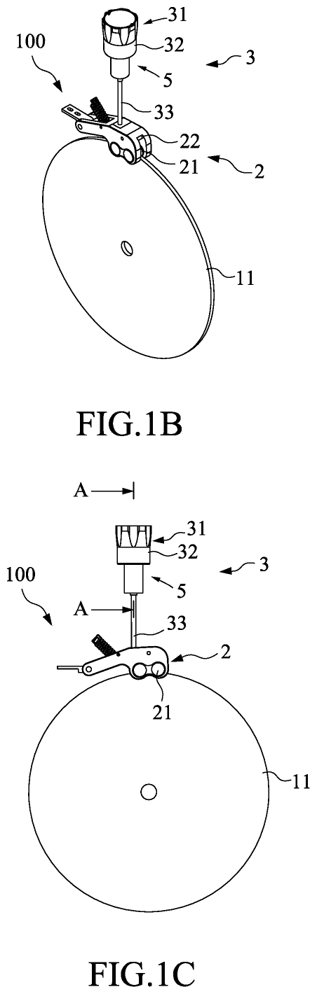

Referring to FIG. 1A, which shows resistance adjustment system 100 for a stationary exercise equipment according to a first embodiment of the present invention mounted to a frame 10 of a stationary bicycle 1, the stationary bicycle 1 is provided with a flywheel 11 and a pedal 12. When a user treads the pedal 12, the flywheel 11 is driven to rotate.

Also referring to FIGS. 1B and 1C, the resistance adjustment system 100 according to the first embodiment of the present invention is operable to adjust or regulate a resisting force that a magnet-based resistance device 2 applies to the flywheel 11, so as to generate an effect of exercise similar to a regular outdoor bicycle. Further, a dual-mode resistance adjustment device 3 is provided to allow the stationary exercise equipment resistance adjustment system 100 according to the present invention to be selectively operated in an electrical operation mode or a manual operation mode. The magnet-based resistance device 2 comprises at least one permanent magnet 21.

When the user forcibly presses down the dual-mode resistance adjustment device 3, a transmission assembly 33 is forced to move downward, so that a braking member 22 of the magnet-based resistance device 2 applies, in a downward direction, a pressing force to a wheel surface of the flywheel 11 to stop the flywheel 11, and thus achieving an effect of emergency braking.

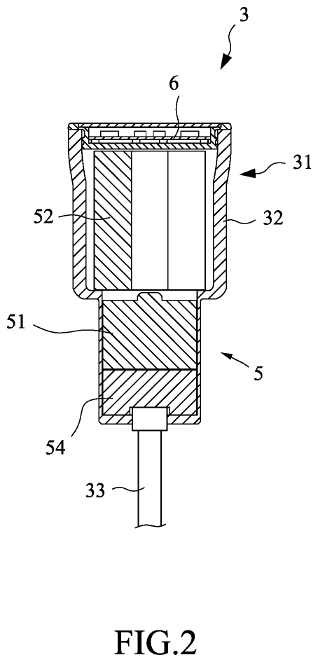

FIG. 2 is a cross-sectional view taken along line A-A of FIG. 1C, which shows the dual-mode resistance adjustment device 3 comprises a manual adjustment member 31 and an electrical adjustment member 5. The manual adjustment member 31 comprises a casing 32 that is rotatable, or undergoes other types of operations, as being operated by an operator. The manual adjustment member 31 is mechanically coupled to the transmission assembly 33. The electrical adjustment member 5 comprises a power unit 51, a power source 52, wherein the power unit 51 has a spindle that is connected, by means of a gear train 54, to the transmission assembly 33 (which can be, or include, for example a screw rod).

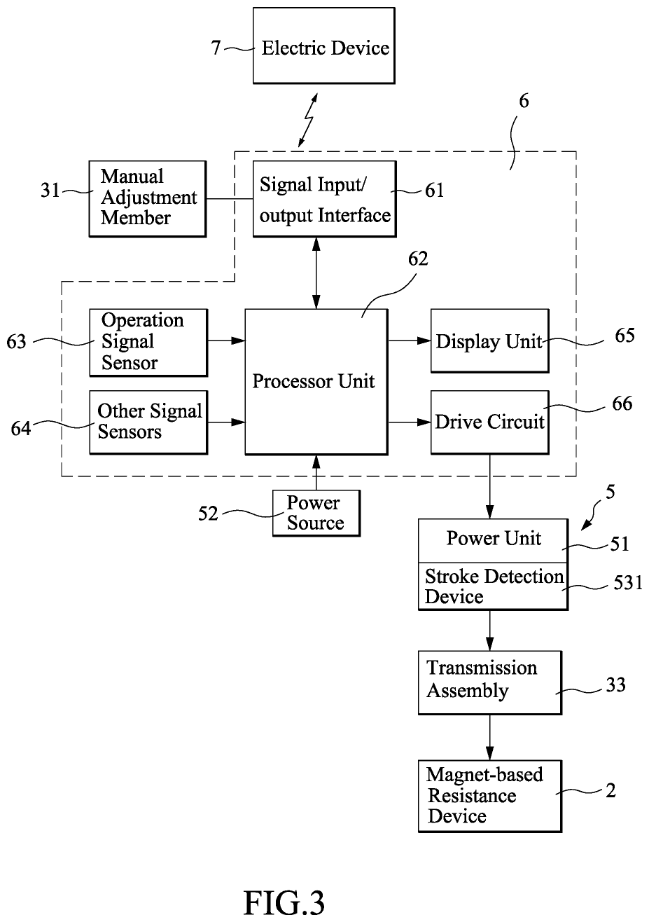

FIG. 3 shows a circuit block diagram of the first embodiment shown in FIGS. 1A, 1B, and 1C. A resistance control circuit 6 comprises a signal input/output interface 61, a processor unit 62, an operation signal sensor 63, other signal sensors 64, a display unit 65, and drive circuit 66, wherein these circuit components are supplied with electrical power from the power source 52.

The signal input/output interface 61 is operable to receive a resistance value signal transmitted from an electronic device 7 (such as an electronic bicycle dashboard, a smart mobile phone, a tablet computer, a computer, a workstation, and cloud) for transmission to the processor unit 62, or to transmit a signal from the processor unit 62 to the electronic device 7. The manual adjustment member 31 is also connected to the signal input/output interface 61. The operation signal sensor 63 can be an angle sensor, a turn-count sensor, a stage sensor, or a magnetometer, and said other signal sensors 64 can be example a touch-control sensor, a speed sensor, and the likes.

In the manual operation mode, the user operates the manual adjustment member 31 to control a stroke of the transmission assembly 33, so as to change the magnitude of the resisting force that the magnet-based resistance device 2 applies to the flywheel 11. During the user's manual operation of the manual adjustment member 31, the operation signal detector 63 is also operable to detect an operation signal for transmission to the processor unit 62, and further transmission through the signal input/output interface 61 to the electronic device 7.

In the electrical operation mode, the electronic device 7 generates a resistance value signal that is supplied through the signal input/output interface 61 to the processor unit 62, and then, the processor unit 62 generates, by means of the drive circuit 66, a driving signal to drive the power unit 51 to rotate and thus drive the transmission assembly 33, so as to vary the resisting force that the magnet-based resistance device 2 applies to the flywheel 11. The power unit 51 may be combined with a stroke detection device 531.

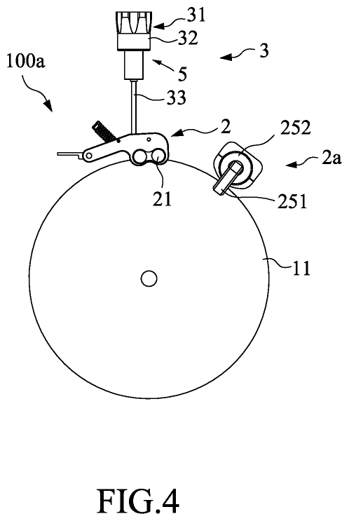

FIG. 4 shows a resistance device according to a second embodiment of the present invention arranged at a location adjacent to a flywheel. The structural components of the instant embodiment are generally the same as those of the first embodiment shown in FIGS. 1B and 1C, and thus, the same components/parts are designated with the same reference numerals for consistency. In addition to those components similar to the first embodiment, the stationary exercise equipment resistance adjustment system 100a of the instant embodiment further comprises an electromagnetic resistance device 2a. The electromagnetic resistance device 2a comprises a C-shaped silicon steel plate 251 and a winding or coil 252. The C-shaped silicon steel plate 251 is arranged to correspond to two side surfaces of the flywheel 11.

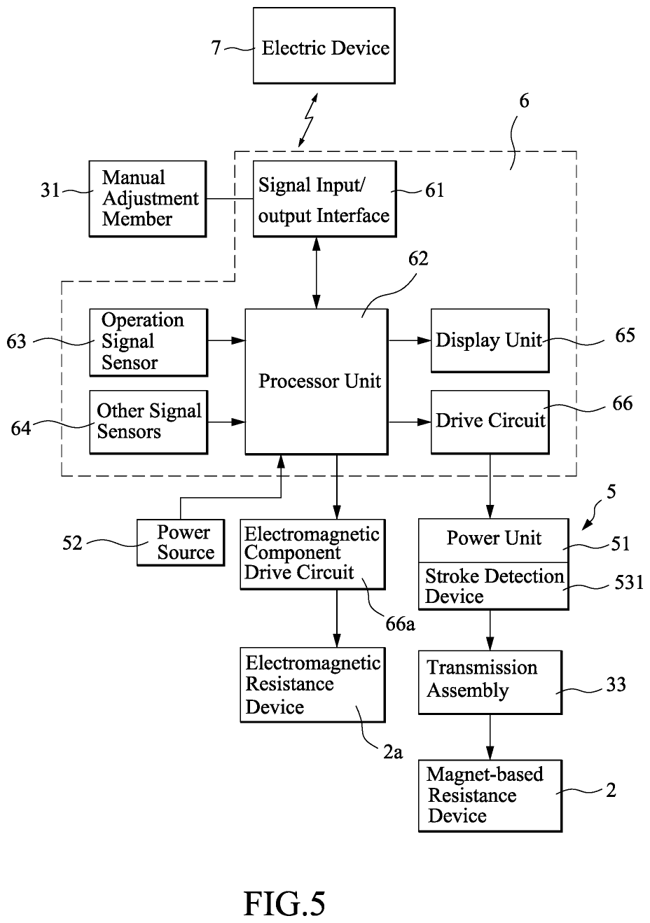

FIG. 5 shows a circuit block diagram of the second embodiment of the present invention shown in FIG. 4. Circuit components of the instant embodiment are generally the same as those of the embodiment shown in FIG. 3. In the instant embodiment, the processor unit 62 is further connected to an electromagnetic component drive circuit 66a. The processor unit 62 generates a driving signal via the electromagnetic component drive circuit 66a to drive the electromagnetic resistance device 2a.

In practical uses, taking simulation of a bicycle as an example, the magnet-based resistance device 2 serves as derailleur of the bicycle (meaning applying a first resisting force to the flywheel 11), and the electromagnetic resistance device 2a may serve as control of slope resistance (meaning applying a second resisting force to the flywheel 11).

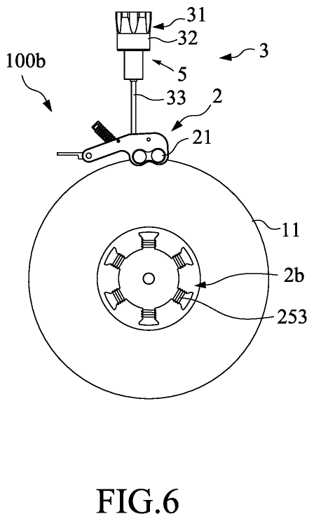

FIG. 6 shows a stationary exercise equipment resistance adjustment system 100b according to a third embodiment of the present invention, which, in addition to components that are the same as those of the first embodiment, further includes a pole-coil-based resistance device 2b. The pole-coil-based resistance device 2b comprises a plurality of pole-wound coils 253 coaxially mounted on the flywheel 11. By changing magnetic induction between the pole-coil-based resistance device 2b and the pole-wound coils 253, the resisting force applied to the flywheel 11 is varied. The pole-coil-based resistance device 2b can be embedded inside the flywheel 11.

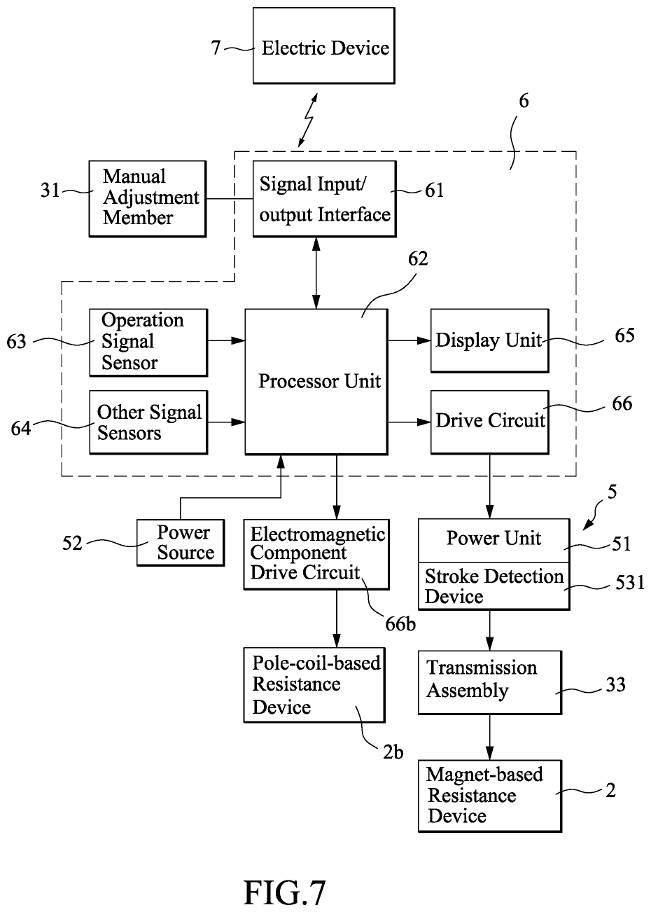

FIG. 7 shows a circuit block diagram of the third embodiment of the present invention shown in FIG. 6. Circuit components of the instant embodiment are generally the same as those of the embodiment shown in FIG. 3. In the instant embodiment, the processor unit 62 is further connected to an electromagnetic component drive circuit 66b. The processor unit 62 generates a driving signal by means of the electromagnetic component drive circuit 66b to drive the pole-coil-based resistance device 2b.

In practical uses, taking simulation of a bicycle as an example, the magnet-based resistance device 2 serves as derailleur of the bicycle (meaning applying a first resisting force to the flywheel 11), and the pole-coil-based resistance device 2b may serve as control of slope resistance (meaning applying a second resisting force to the flywheel 11).

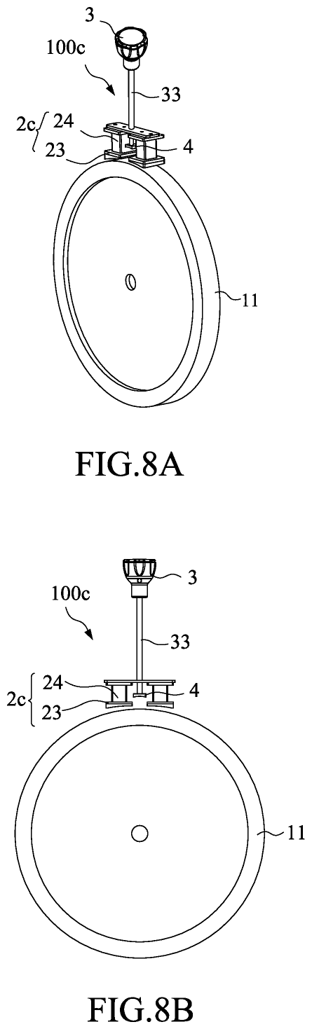

FIGS. 8A and 8B are respectively a perspective view and a side elevational view showing a positional relationship of type I of a fourth embodiment of the present invention corresponding to a flywheel. The stationary exercise equipment resistance adjustment system 100c of the instant embodiment comprises an electromagnetic resistance device 2c including an electromagnetic pole 23 and a winding 24 wound around the electromagnetic pole 23. The electromagnetic pole 23 is arranged to face a metallic material formed on an outside surface or a side surface of the flywheel 11. Examples of the metallic material include a product made of aluminum, copper, or cast iron, or may include a layer of metal film formed on the outside surface of the flywheel 11.

When the flywheel 11 is rotating, the metal material of the flywheel 11 cut a magnetic field generated by the winding 24, and thus, an eddy current is inducted on the metal material of the flywheel 11. The eddy current and the electromagnetic pole 23 generate a resisting force through mutual attraction or repulsion. The magnitude of the magnetic force generated by the winding 24 can be controlled through a PWM (Pulse Width Modulation) signal.

A lower end of the transmission assembly 33 is mounted with a braking member 4. When the user forcibly presses down the manual adjustment member 31, the transmission assembly 33 is forced to move downward, so that the braking member 4 applies a pressing force to the wheel surface of the flywheel 11 to stop the flywheel 11, and thus achieving an effect of emergency braking.

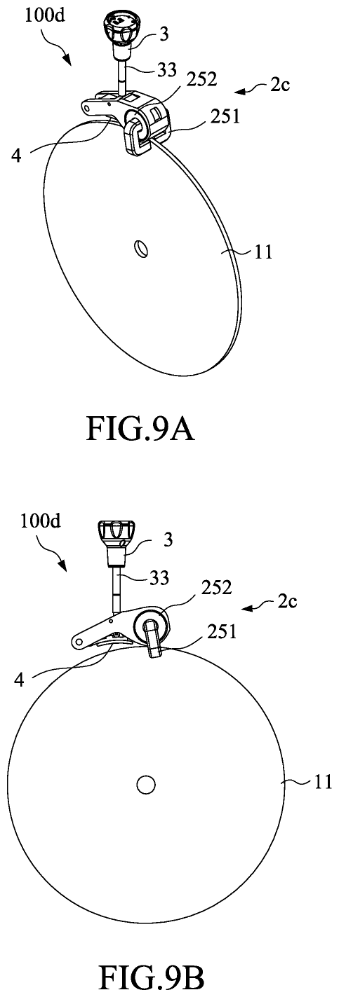

FIGS. 9A and 9B are respectively a perspective view and a side elevational view showing a positional relationship of type II of the fourth embodiment of the present invention corresponding to a flywheel. An electromagnetic resistance device 2c of a stationary exercise equipment resistance adjustment system 100d according to the instant embodiment comprises a C-shaped silicon steel plate 251 and a winding or coil 252. The C-shaped silicon steel plate 251 is arranged to correspond to two side surfaces of the flywheel 11. In the instant embodiment, the electromagnetic resistance device 2c is also provided, on a lower end surface thereof, with a braking member 4.

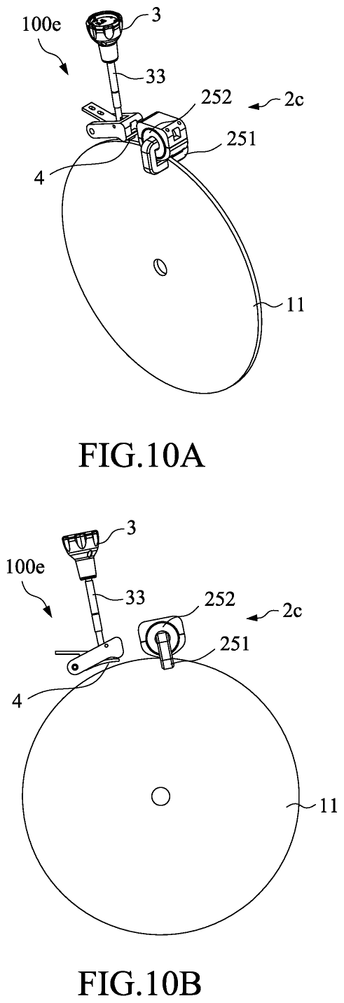

FIGS. 10A and 10B are respectively a perspective view and a side elevational view showing a positional relationship of type III of the fourth embodiment of the present invention corresponding to a flywheel. An electromagnetic resistance device 2c of a stationary exercise equipment resistance adjustment system 100e according to the instant embodiment comprises a C-shaped silicon steel plate 251 and a winding or coil 252. The C-shaped silicon steel plate 251 is arranged to correspond to two side surfaces of the flywheel 11. In the instant embodiment, the electromagnetic resistance device 2c is also provided, on a lower end surface thereof, with a braking member 4.

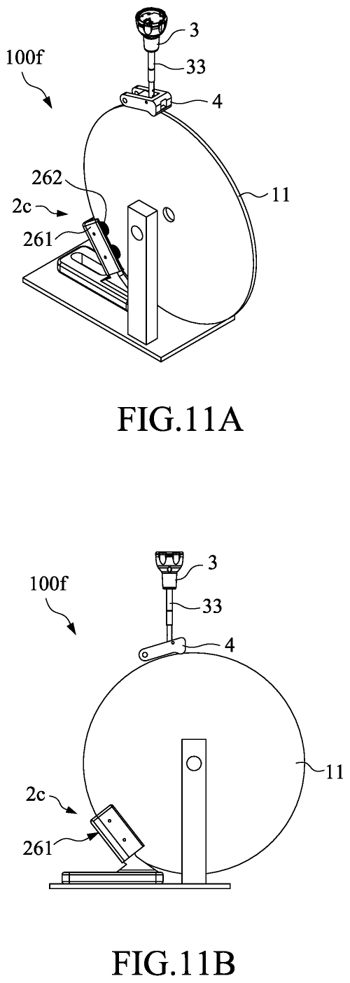

FIGS. 11A and 11B are respectively a perspective view and a side elevational view showing a positional relationship of type IV of the fourth embodiment of the present invention corresponding to a flywheel. An electromagnetic resistance device 2c of a stationary exercise equipment resistance adjustment system 100f according to the instant embodiment comprises a braking member 4 connected to a lower end of the transmission assembly 33, and an electromagnet 261 and a winding or coil 262. Positional arrangement of the electromagnet 261 and the winding 262 may be set to a location corresponding to a lower part or bottom of the flywheel 11. When the transmission assembly 33 is forcibly pressed down by the user, the braking member 4 applies a pressing force to the flywheel 11 to cause emergency braking of the flywheel 11. The electromagnet 261 may be made of a material including a silicon steel plate or a metal pole of high magnetic permeability.

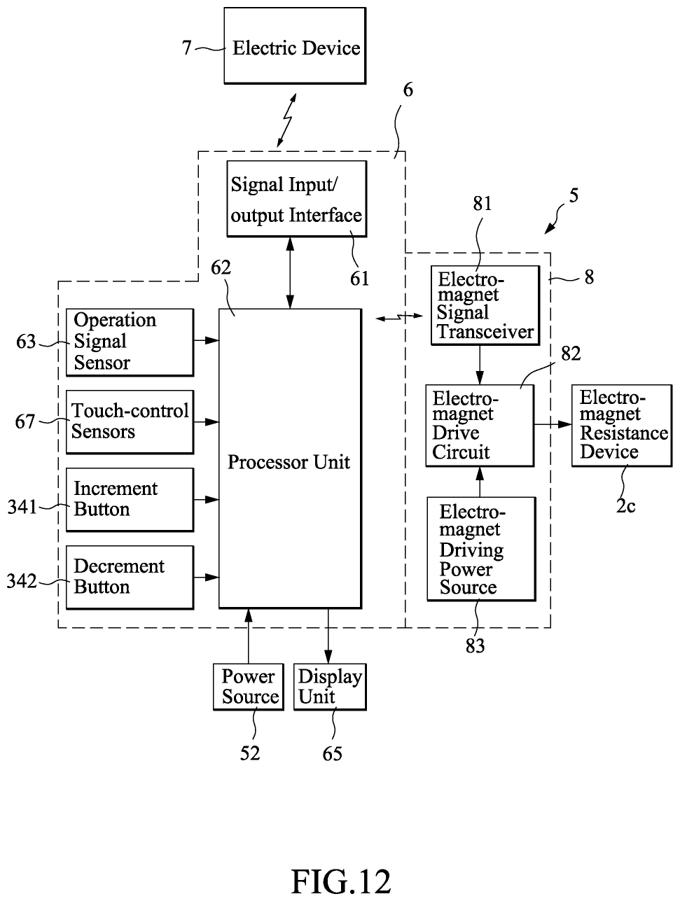

FIG. 12 shows a circuit block diagram of the fourth embodiment of the present invention shown in FIGS. 8A-11B. Similar to the circuit block diagram of the embodiment shown in FIG. 3, circuit components of the resistance control circuit 6 include a signal input/output interface 61, a processor unit 62, an operation signal sensor 63, a display unit 65, and a touch-control sensor 67. The electrical adjustment member 5 of this embodiment includes an electromagnetic drive unit 8 which comprises an electromagnet signal transceiver 81, an electromagnetic drive circuit 82, and an electromagnet driving power source 83.

In the electrical operation mode, the electronic device 7 generates a resistance value signal that is transmitted through the signal input/output interface 61 to the processor unit 62, and is also transmitted through the signal input/output interface 61 to an electromagnet signal transceiver 81 to allow an electromagnetic drive circuit 82 to drive the electromagnetic resistance device 2c so as to change the resisting force applied to the flywheel 11.

Further, the processor unit 62 can be connected, in a wireless or wired manner, with an increment button 341 and a decrement button 342. When the processor unit 62 receives a resistance adjustment signal generated through operation of the increment button 341 and/or the decrement button 342, the processor unit 62 generates a driving signal that is transmitted through the signal input/output interface 61 to the electromagnet signal transceiver 81, in order to allow an electromagnetic drive circuit 82 to drive the electromagnetic resistance device 2c to change the resisting force applied to the flywheel 11.

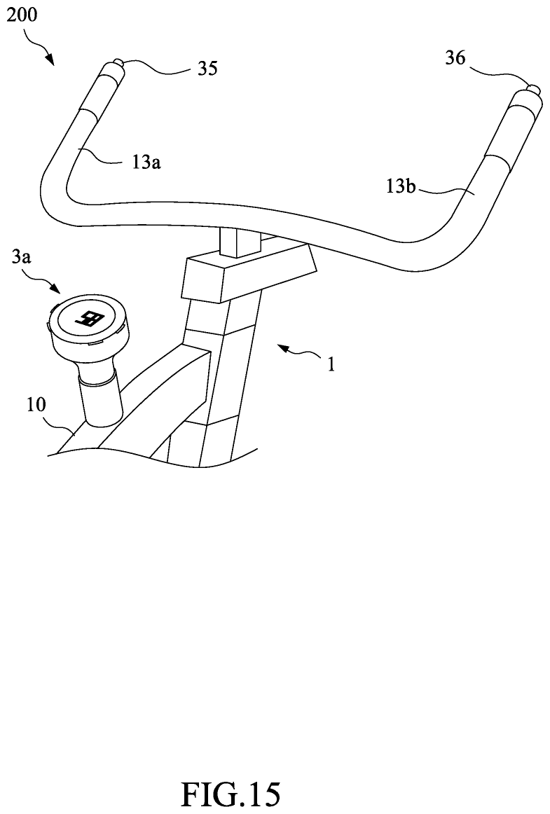

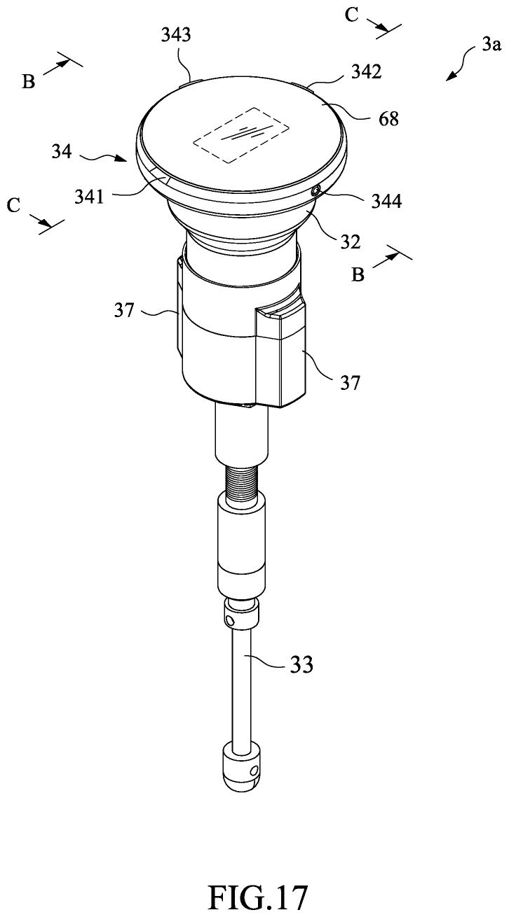

The increment button 341 and the decrement button 342 can be arranged on a left grip 13a or a right grip 13b that will be discussed hereinafter in a different embodiment (such as that shown in FIG. 15) or provided on the manual adjustment member 31 (as shown in FIG. 17), so that the electromagnetic field intensity of the electromagnet 261 of the electromagnetic resistance device 2c can be adjust or regulate by the increment button and the decrement button, or the electronic device 7.

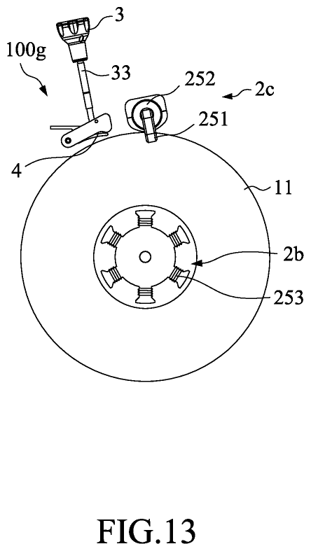

FIG. 13 is a side elevational view illustrating a positional relationship of a resistance device of a fifth embodiment of the present invention corresponding to a flywheel. The instant embodiment is similar to the embodiment shown in FIG. 10B, but additionally include a pole-coil-based resistance device 2b. The pole-coil-based resistance device 2b is coaxially mounted to the flywheel 11 and includes a plurality of pole-wound coils 253. When the user forcibly presses down the manual adjustment member 31, the transmission assembly 33 is forced to move downward, so that the braking member 4 applies a pressing force to the wheel surface of the flywheel 11 to stop the flywheel 11.

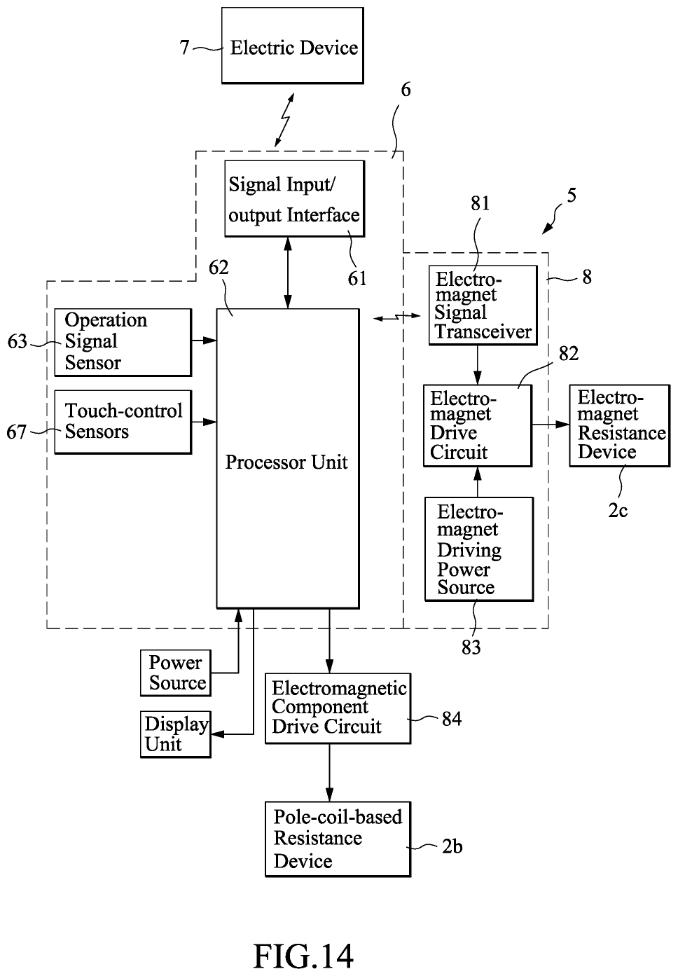

FIG. 14 shows a circuit block diagram of the fifth embodiment of the present invention shown in FIG. 13. Circuit components of the instant embodiment are generally the same as those of the embodiment shown in FIG. 3. In the instant embodiment, the processor unit 62 is further connected to an electromagnetic component drive circuit 84. The processor unit 62 generates a driving signal that is applied, via the electromagnetic component drive circuit 84, to drive the pole-coil-based resistance device 2b.

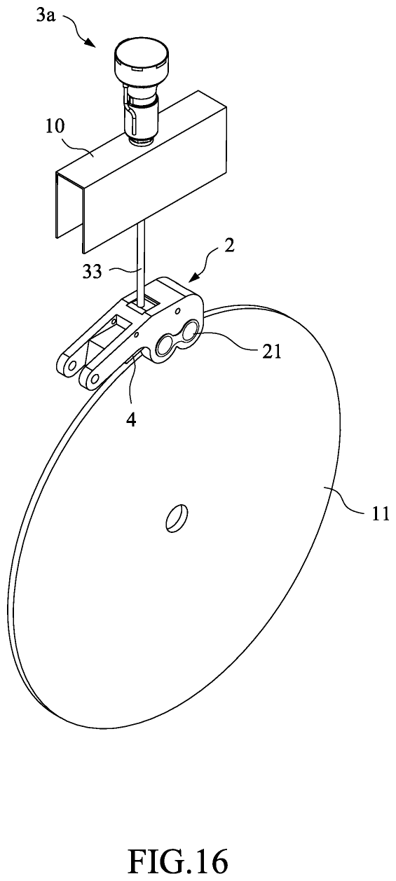

Referring to FIG. 15, it is a schematic view illustrating a stationary exercise equipment resistance adjustment device 200 according to a sixth embodiment of the present invention mounted to a frame 10 of a stationary bicycle 1. FIG. 16 shows a resistance adjustment device 3a and a magnet-based resistance device 2 of the stationary exercise equipment resistance adjustment system 200 according to the sixth embodiment mounted are mounted at a location adjacent to a flywheel 11. The magnet-based resistance device 2 comprises at least one permanent magnet 21. The magnet-based resistance device 2 is driven by the resistance adjustment device 3a, during a movement stroke thereof, to change a distance thereof relative to the flywheel 11, in order to change the resisting force applies to the flywheel 11.

The stationary bicycle 1 includes a left grip 13a and a right grip 13b that are respectively provided with an increment button 35 and a decrement button 36. Similarly, the increment button 35 and the decrement button 36 can each be a control button of either a mechanical button or a touch-control button.

When the user forcibly presses down the resistance adjustment device 3a, the transmission assembly 33 is forced to move downward, so that the braking member 4 mounted at the lower end of the magnet-based resistance device 2 applies a pressing force to the wheel surface of the flywheel 11 to stop the flywheel 11. Further, the casing 32 of the resistance adjustment device 3a may be provided, on a side wall thereof with a pair of corresponding slide rails 37, for the purposes of reducing frictional force with respect to the frame 10 during operation and movement, in order to make the movement smooth.

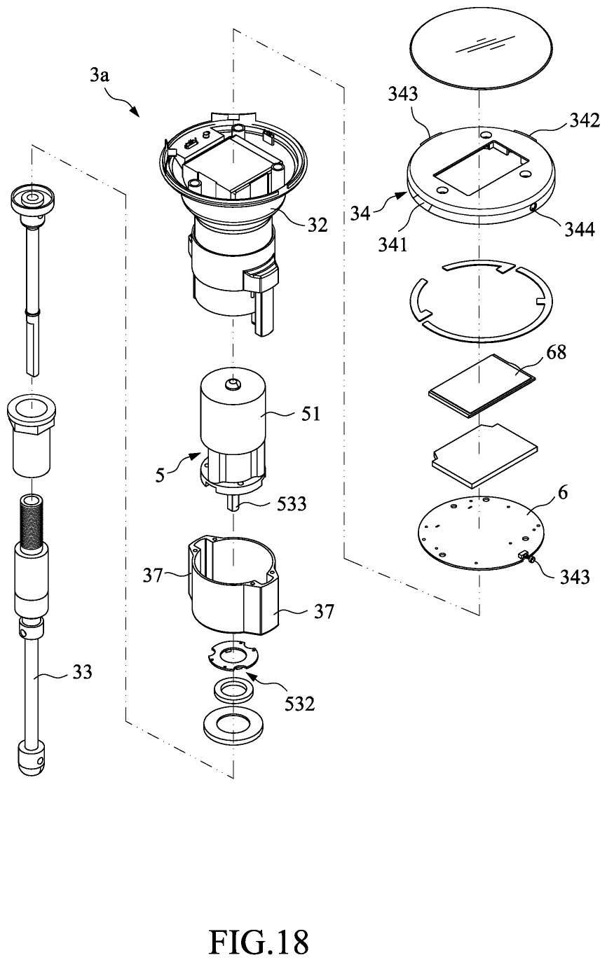

Referring to FIGS. 17 and 18, the resistance control circuit 6 is arranged inside the casing 32, and the resistance control circuit 6 is in electrical connection with a display unit 68. The display unit 68 can be one of a liquid crystal display (LCD), a light-emitting diode (LED) display, or an external display device (such as one that is independent of or separate from the casing 32).

In the circumference of the casing 32 of the resistance adjustment device 3a, a pushbutton-fashion manual adjustment member 34 is arranged at a predetermined location that is convenient for operation by the user and is in electrical connection with the resistance control circuit 6. When the user operates the pushbutton-fashion manual adjustment member 34, a resistance adjustment signal is generated and applied to the resistance control circuit 6.

The pushbutton-fashion manual adjustment member 34 comprises an increment button 341 and a decrement button 342. In a preferred embodiment, the pushbutton-fashion manual adjustment member 34 may also comprises a mode selection button 343 and a setting button 344.

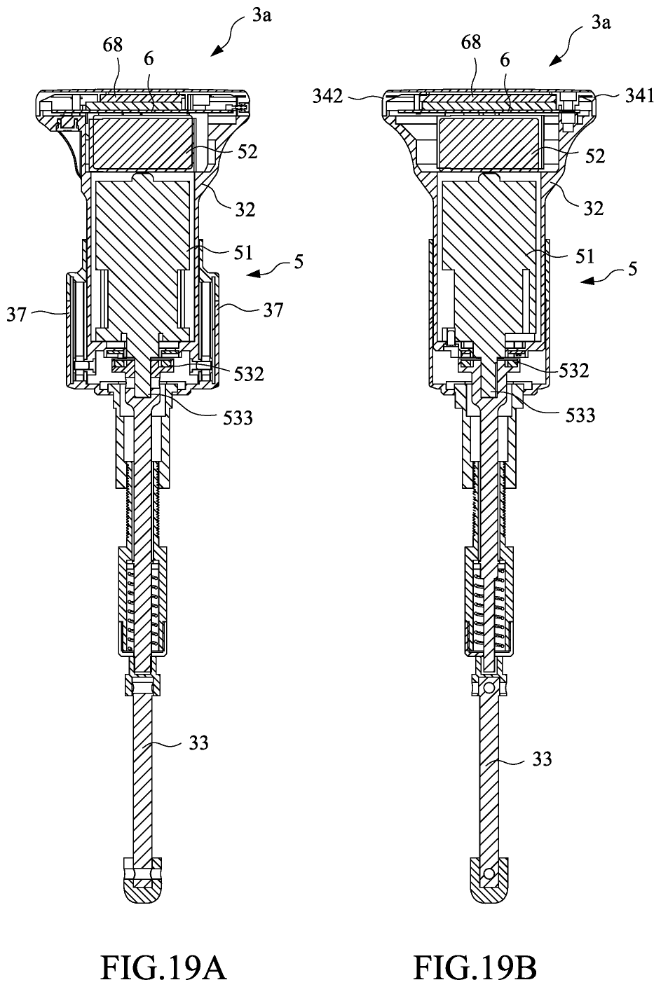

Also referring to FIGS. 19A and 19B, the electrical adjustment member 5 includes a power unit 51. The power unit 51 is in electrical connection with the resistance control circuit 6. The resistance control circuit 6, upon receiving a resistance adjustment signal from the increment button 341 or the decrement button 342, generates a driving signal to drive the power unit 51.

In the instant embodiment, an angle detection unit 532 may be further included, which can be one of a magnetic material, an optical material, an encoder, a magnetometer, a gyroscope, a gear, and a Hall sensor. For example, the angle detection unit 532 may comprises a magnetic element and a circuit board that is mounted, in a manner of corresponding thereto, on the transmission assembly 33. When the circuit board is rotated with the rotation of the transmission assembly 33, the magnetic coupling thereof with respect to the magnetic element can be used to detect an angular position of the transmission assembly 33.

The transmission assembly 33 comprises a screw rod, which is connected to a rotary spindle 533 of the power unit 51, and is driven by the rotary spindle 533 to rotate in order to make a moving stroke.

Electrical power required for operation of the resistance control circuit 6 and the power unit 51 can be supplied from and by the power source 52. The power source 52 can be one of a rechargeable battery, a primary battery, and an external electrical power source.

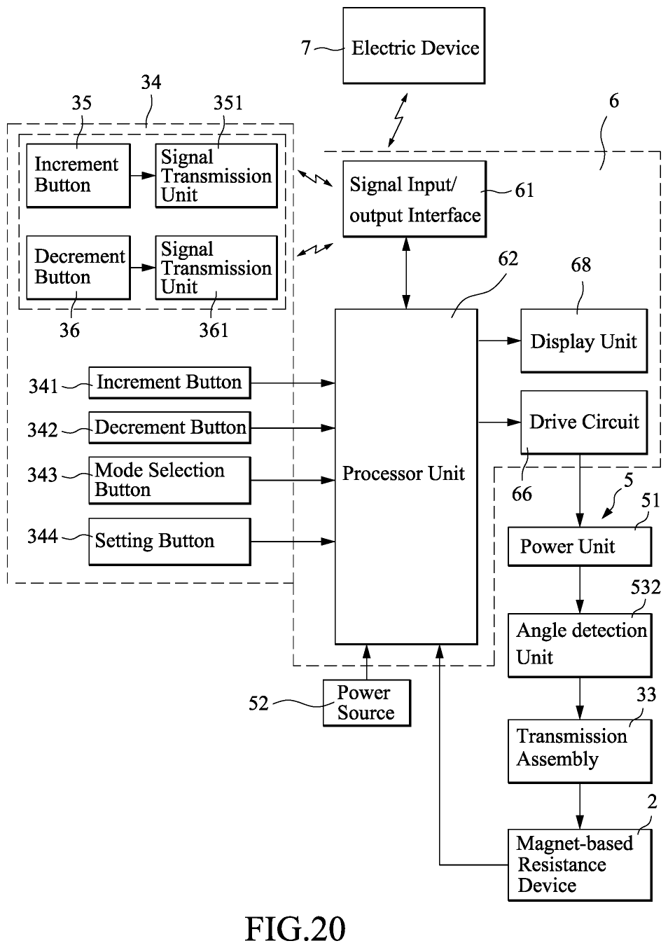

FIG. 20 is a circuit block diagram of the sixth embodiment of the present invention shown in FIGS. 15-19B. As shown in the drawing, the resistance control circuit 6 comprises a signal input/output interface 61, a processor unit 62, a drive circuit 66, and a display unit 68.

When the processor unit 62 receives a resistance adjustment signal generated through operation of the increment button 341 and/or the decrement button 342, the processor unit 62 generates a driving signal applied to the drive circuit 66, and the drive circuit 66 drives the power unit 51. Power generated by the power unit 51 drives the transmission assembly 33 to generate a moving stroke to the magnet-based resistance device 2.

Upon being driven to rotate, the power unit 51 uses the angle detection unit 532 to detect a rotation angle of the transmission assembly 33 and an angular signal is generated and fed back to the processor unit 62.

During operation, the increment button 35 and the decrement button 36 that are disposed on the left grip 13a and the right grip 13b of the stationary bicycle 1 transmit, by means of signal transmission units 351, 361, in a wireless manner, the resistance adjustment signal to the signal input/output interface 61, for subsequent transmission to the processor unit 62. The processor unit 62 similarly generates a driving signal applied to the drive circuit 66, and the drive circuit 66 drives the power unit 51. Power generated by the power unit 51 drives the transmission assembly 33 to generate a moving stroke to the magnet-based resistance device 2.

Preferably, a resistance adjustment signal generated by an electronic device 7 is transmitted through the signal input/output interface 61 to the processor unit 62, so that the processor unit 62 generates a driving signal to the drive circuit 66, to allow the drive circuit 66 to drive the power unit 51, and then, the transmission assembly 33 generates a moving stroke to the magnet-based resistance device 2.

Based on the structural arrangements provided above, the present invention is fit for the virtual reality technology and the need for group exercise training, exercise power training, and cardiovascular training in virtual reality, for being used in a virtual-reality landform (such as slope variation for uphill and downhill and various levels of riding difficulty in respect of resistance and level shifting of resistance), or terrain features (such as emergency braking), or change among different difficulty levels in virtual reality, and so on, for realization of synchronization with various situations in virtual reality, so that during exercise training, the user may achieve a scenario of unification among man, machine, and controller. Further, the structural arrangement of present invention allows for enjoyment of the interesting of instantaneous man-vehicle interaction for emergency and an interaction process of the man-vehicle interface.

In practical uses, the present invention is applicable to stationary exercise equipment including an indoor stationary bicycle, a rowing machine, an indoor bicycle trainer, an elliptical trainer, a treading machine, a climbing trainer, a jogging machine, and a spinner bike.

The embodiments provided above are only for illustration of the present invention and are not intended to limit the scope of the present invention. Equivalent variations and substitutes that fall within the spirit of the present invention are considered within the scope of the present invention that is solely defined in the appended claims.

What is claimed is:

1. A resistance adjustment system adapted to adjust a resisting force applies to a flywheel of a stationary exercise equipment, comprising:
a casing mounted to a frame of the stationary exercise equipment;
a resistance control circuit arranged in the casing;
a pushbutton-fashion manual adjustment member including an increment button and a decrement button electrically connected to the resistance control circuit, operable by a user to generate a resistance adjustment signal to the resistance control circuit;
a power unit electrically connected to the resistance control circuit, wherein, in response to receipt of the resistance adjustment signal from the manual adjustment member, the resistance control circuit generates a driving signal to drive the power unit;
a transmission assembly having an end connected to the power unit; and
a resistance device connected to an opposite end of the transmission assembly, wherein the power unit drives, via the transmission assembly, the resistance device to move so as to cause a change of the resisting force applied to the flywheel.

2. The resistance adjustment system according to claim 1, wherein the resistance control circuit comprises:
a processor unit;
a signal input/output interface, which is connected to the processor unit; and
a drive circuit, which is connected to the processor unit and the power unit;
wherein the processor unit receives the resistance adjustment signal from the manual adjustment member, such that the processor unit generates the driving signal to the drive circuit, to allow the drive circuit to drive the power unit.

3. The resistance adjustment system according to claim 1, further comprising a display unit, which is disposed on the casing and is in electrical connection with the processor unit, wherein the display unit is one of a liquid crystal display (LCD), a light-emitting diode (LED) display, and an external display device.

4. The resistance adjustment system according to claim 1, wherein:
the power unit comprises:
a motor, which is connected to the transmission assembly;
an angle detection unit, which is connected to the transmission assembly to detect a rotation angle of the transmission assembly and to generate an angular signal to the resistance control circuit, wherein the angle detection unit comprises one of a magnetic material, an optical material, an encoder, a magnetometer, a gyroscope, a gear, and a Hall sensor; and
the transmission assembly further comprises:
a screw rod, which is connected to a rotary spindle of the power unit and is driven by the rotary spindle to generate the movement stroke.

5. The resistance adjustment system according to claim 1, wherein the increment button and the decrement button of the manual adjustment member are respectively disposed on a left grip and a right grip of the stationary exercise equipment.

6. The resistance adjustment system according to claim 1, wherein the increment button and the decrement button of the manual adjustment member are disposed on the casing.

7. The resistance adjustment system according to claim 1, wherein the increment button and the decrement button are each one of a mechanical button and a touch-control button.

8. The resistance adjustment system according to claim 1, wherein the resistance device comprises one of a permanent magnet and an electromagnet unit.

9. The resistance adjustment system according to claim 1, wherein when the resistance adjustment device is downward depressed to move the transmission assembly downward, a braking member mounted at a lower end of the transmission assembly applies a pressing force to the wheel surface of the flywheel to stop the flywheel.

10. A resistance adjustment system adapted to control a resisting force that an electromagnetic resistance device applied to a flywheel of a stationary exercise equipment, comprising:
a resistance control circuit with a signal input/output interface for receiving a resistance value signal transmitted from an electronic device;
a power source for supplying electricity to the signal input/output interface and the resistance control circuit;
a transmission assembly;
a manual adjustment member coupled to the transmission assembly; and
an electrical adjustment member including an electromagnetic drive unit electrically connected to the electromagnetic resistance device, wherein the electromagnetic drive unit includes an electromagnet signal transceiver and an electromagnetic drive circuit in electrical connection with the electromagnet signal transceiver, wherein the resistance value signal transmitted from the electronic device is transmitted through the signal input/output interface to the electromagnet signal transceiver to allow the electromagnetic drive circuit to drive the electromagnetic resistance device to cause a change of the resisting force applied to the flywheel.

11. The resistance adjustment system according to claim 10, wherein the electromagnetic resistance device includes an electromagnetic pole and a winding wound around the electromagnetic pole, wherein the electromagnetic pole is arranged to face a metallic material formed on one of an outside surface and a side surface of the wheel, wherein when the flywheel is rotating, the metal material of the flywheel cuts a magnetic field generated by the winding, and thus, an eddy current is inducted on the metal material of the flywheel to generate a resisting force to the wheel.

12. The resistance adjustment system according to claim 10, wherein the electronic device comprises one of an electronic bicycle dashboard, a smart mobile phone, a tablet computer, a computer, a workstation, and cloud.

13. The resistance adjustment system according to claim 10, wherein the resistance control circuit comprises:
a processor unit connected to the signal input/output interface;
an operation signal detector connected to the processor unit; and
a drive circuit connected to the processor unit and the power unit;
wherein the operation signal detector detects an operation signal generated through operation of the manual adjustment member and the operation signal is transmitted through the signal input/output interface to the electronic device, and wherein the operation signal comprises one of an angle signal, a turn-count signal, and a stage signal.

14. The resistance adjustment system according to claim 10, wherein when the manual adjustment member is downward depressed to move the transmission assembly downward, a braking member mounted at a lower end of the transmission assembly applies a pressing force to the wheel surface of the flywheel to stop the flywheel.

15. The resistance adjustment system according to claim 10, wherein the stationary exercise equipment comprises one of an indoor stationary bicycle, a rowing machine, an indoor bicycle trainer, an elliptical trainer, a treading machine, a climbing trainer, a jogging machine, and a spinner bike.

16. The resistance adjustment system according to claim 10, further comprising a pole-coil-based resistance device, which comprises a plurality of pole-wound coils coaxially mounted to the flywheel.
